(19) United States
(12) Patent Application Publication
(10) Pub. No.: US 2002/0070648 A1
(43) Pub. Date: Jun. 13, 2002

(54) Field emitting cathode and a light source using a field emitting cathode

(76) Inventor: Gunnar Forsberg, Askim (SE)

Correspondence Address: BIRCH STEWART KOLASCH & BIRCH, PO BOX 747, FALLS CHURCH, VA, 22040-0747, US

(21) Appl. No.: 09/731,737

(22) Filed: Dec. 8, 2000

(51) Int. Cl. H01J 1/02; H01J 19/10

(52) U.S. Cl. 313/309; 313/336; 313/351

(57) ABSTRACT

This invention relates to a field emission cathode (1) for a light source. The cathode (1) comprises at least one base body (3) having an emission surface (3′). Further, the base body (3) is formed by a structured material, and the emission surface (3′) is at least partly covered by a field emitting nano-structured material (2). Moreover, this invention relates to a light source, comprising an anode (5), a cathode (1) and an evacuated container (6) enclosing the anode (5) and the cathode (1). The container (6) have at least one inner wall being provided with a luminescent layer (4) as well as a conductive layer forming said anode (5) and the cathode (1) is a field emission cathode of the above mentioned type.

### FIELD OF THE INVENTION

This invention relates to a field emission cathode for a light source, said cathode comprising at least one base body having an emission surface. The invention also concerns a light source comprising such a cathode.

### BACKGROUND OF THE INVENTION

On the market today, there are a great number of different illumination devices. The most common are light bulbs, based on thermionic stimulus, and fluorescent tubes, based on gas discharge. A third category of illumination devices is field emission devices and, accordingly, cathodes used in this kind of devices are called field emission cathodes. For illumination purposes, field emission cold cathodes, which do not require a heat source to operate, are preferably used. However, the use of field emission devices for illumination purposes is currently not wide spread.

Field emission cold cathodes used in light sources for illumination has several advantages over devices using thermionic stimulus. Field emission cold cathode devices generally require less power in order to produce the same emission current than a thermionic device. As a matter of fact a field emission source may be 1000 times brighter, compared to a thermionic device. Further, thermionic devices tend to have a short life span, due to burn out. They are also temperature dependent, resulting in bad performance in extreme temperature surroundings. This is not the case with field emission cold cathode devices being based solely on electric field strength and applied voltage over the anode and the cathode.

Further, fluorescent tubes, employing gas discharge for emitting radiation onto a fluorescent material that in turn emits light, do overcome some of the disadvantages with for example the light bulb, such as their short life span and their relatively low brightness. However, fluorescent tubes require complicated external electrical devices for their function and they typically contain materials, such as mercury, having negative environmental effects. This is not the case with field emission devices.

Consequently, there are many advantages pointing towards a more extended use of field emission cold cathode devices for illumination purposes.

Some efforts have been done in constructing a light source utilizing a field emission cold cathode. An example of such a construction is described in the patent document WO 98/57345, showing a cold field emission cathode for use in a field emission light source. This construction includes a base body and field emitting fibers being attached to the body, said fibers having field emitting irregular surfaces at their free ends. This cathode has been proven to function well, but is however somewhat complicated and time consuming to manufacture, resulting in a rather expensive construction.

Further, various materials have been proven to be feasible when constructing field emission cathodes. However, carbon-based materials have turned out to be especially useful in this area. Field emission cathodes using compact, essentially homogeneous carbon and graphite have been developed, but these cathodes all require the application of a substantial voltage before generating significant electron emission. Other cathodes using for example individual fiber bundle formations, as in WO 98/57345, and matrix formations in which carbon surfaces are formed by photolithography or the like, have also been suggested, but these cathodes have proven not to be suitable for mass production.

Resent developments in the carbon material field has resulted in structured, oriented carbon materials, making it possible to lower the field emission cathode voltages required to produce substantial electron emission. Such a material, and its use in a field emission cathode, is described in the publication WO 99/43870. This material is referred to as porous carbon foam, a material having an emissive surface, which define a multiplicity of emissive edges. Regarding this material and its characteristics, reference is given to WO 99/43870, incorporated herein by reference. This material, also referred to as Reticulated Vitreous Carbon™, has the advantages of being easy to shape and cut, and a field emission cathode manufactured from this material is comparatively inexpensive. However, the field emission density accomplished with this cathode is still rather low, due to problems in adapting the surface of the material to its purpose.

### SUMMARY OF THE INVENTION

Consequently, an object of the invention is to achieve a further improved field emission cold cathode for use in light sources, said cathode being inexpensive and easy to manufacture, even in large volumes, as well as requiring a relatively low voltage application in order to generate significant and stable electron emission. A further object is to achieve a cold cathode able to produce a high field emission density. Yet another object is to achieve a field emission cathode that is efficient and durable. A further object is to accomplish a light source with a field emission cathode, said light source constituting a stable and forgiving system for illumination purposes.

These objects are achieved by a cathode according to the introduction, in which said base body is formed by a structured material, and said emission surface is at least partly covered by a field emitting nano-structured material, In this application, a nano-structured material is defined as a material with physical structures in the range 0.1-100 mn. This construction, with a combination of a structured, oriented material and sharp emitting points created by the nano-structure, results in a cathode requiring a relatively low voltage application in order to generate significant electron emission.

Preferably, said emission surface of said base body is formed as to constitute a three dimensional surface structure, including several protruding areas, at least said protruding areas being covered by nano-structured material. This construction result in areas of emissive nano-structured material on the emission surface, said areas being positioned closer to an presumptuous anode than other areas of the emission surface of the base body, when the cathode is placed in a light source system. Consequently, due to the distance dependence (between anode and cathode) of light emission, emission will occur mainly from said protruding areas, not from the areas in-between. In this way the emission may be controlled. Further, the three-dimensional surface has the advantage of separating the emissive points from each other, much like a matrix structure or the like. This design is advantageous regarding the voltage that must be applied over the cathode in order to achieve a high field emission, since a planar surface with a compact layer of emissive points have somewhat a tendency of acting as a compact, homogeneous material, with the result that a high voltage is needed for field emission. The above-mentioned drawback is avoided with said three-dimensional surface structure.

Further, said protruding areas preferably form an essentially periodical surface structure. In this way the emission may be controlled in order to achieve an even and continuous emission, which is advantageous for acquiring a stable illumination device. According to one embodiment of the invention said periodical surface structure has an essentially square-wave cross section. This structure is fairly easy to produce and offers well-defined areas of emissive material. According to another embodiment of the invention said periodical surface structure has an essentially sinusoidal cross section. This structure provides for an emissive surface without sharp edges in order to achieve a stable emission, without aging due to blunting of sharp edges of the material. According to a third embodiment said periodical surface structure has an essentially saw-tooth shaped cross section, This structure is also quite simple to manufacture. Other shapes and structures are of cause possible. Furthermore said structures may be periodical in one or two dimensions.

Preferably, said structured, oriented material is constituted by a porous carbon material such as a porous carbon foam material, e.g. Reticulated Vitreous carbon™. A field emission cathode manufactured from such a material has especially advantageous properties regarding efficiency and durability as well as simple and inexpensive manufacture. According to another embodiment of the invention, the structured, oriented material is constituted by a semiconductor material. Further, said nano-structured material is advantageously constituted by a layer of carbon nanotubes being arranged on said base body. This provides for a perfect covering of carbon nanotube material, resulting in an even distribution of sharp emissive points over the emission surface.

The invention further relates to a light source, comprising an anode, a cathode and an evacuated container enclosing said anode and said cathode, wherein said container have at least one inner wall being provided with a luminescent layer as well as a conductive layer forming said anode, said light source being characterized in that said cathode is a field emission cathode as described above.

In accordance with one embodiment of the invention, said evacuated container forms the outer boundaries of the light source. This construction includes a minimal number of components, since the anode is integrated with the component forming the outer boundary of the light source. In accordance with another embodiment of the invention said evacuated container is essentially enclosed in a cover/diffusor forming the outer boundaries of the light source. This result in a flexible solution, where a standard size component, comprising the anode as well as the cathode, may be used for manufacturing illumination devices with different outer appearances. This also points towards the fact that the field emission device basically is size independent and may be embodied in virtually any size, independently of the desired luminous flux. This is a significant advantage over for example the compact fluorescent tube, in which size of the illumination device is directly connected to the luminous flux of the light source.

According to the above a light source with a field emission cathode is a much flexible illumination device. It may be formed in any shape, for example as a regular light bulb, making the construction consumer friendly. Further, the construction may easily be manufactured with a regular bulb socket, making it possible to readily exchange any regular light bulb for a field emission lamp, having the above stated advantages.

### BRIEF DESCRIPTION OF DRAWINGS

The invention will hereinafter be described in closer detail with reference to the accompanying drawings, in which:

FIG. 1 is a perspective view of a field emission cathode in accordance with the invention,

FIG. 2a is a cross section view of a field emission cathode with a surface structure according to one embodiment of the invention,

FIG. 2b is a cross section view of a field emission cathode with a surface structure according to a second embodiment of the invention,

FIG. 2c is a cross section view of a field emission cathode with a surface structure according to a third embodiment of the invention,

FIG. 3 is a schematic view of a light source with a field emission cathode in accordance with one embodiment of the invention,

FIG. 4a is a schematic view of a field emission cathode in accordance with a second embodiment of the invention,

FIG. 4b is a schematic view of light source using the field emission cathode shown in FIG. 4a,

FIG. 4c is a schematic cross section view of a light source in accordance with FIG. 4b, being positioned in a light bulb like construction.

FIG. 5a is a schematic cross section view of light source using a field emission cathode basically as shown in FIG. 1, and 5c is a schematic cross section view of a light source in accordance with FIG. 5a, being positioned in a light bulb like construction.

### DESCRIPTION OF PREFERRED EMBODIMENTS

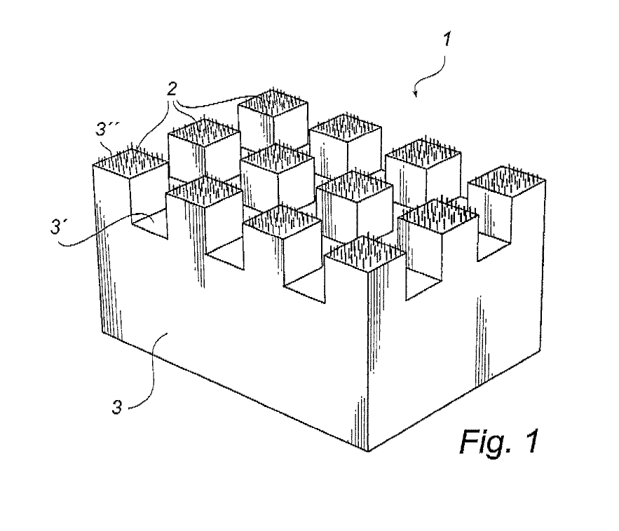

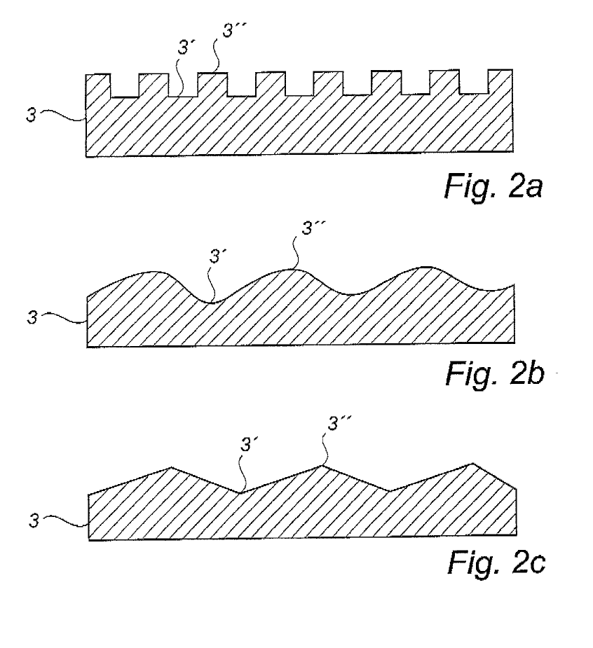

FIG. 1 shows a field emission cathode 1 in accordance with a first embodiment of the invention. The field emission cathode 1 comprises a base body 3, in this case being formed of a porous carbon material, e.g. Reticulated Vitreous CarbonT™, an open cell, reticulated foam material, having a random pore structure with good uniform pore distribution statistically. For further information about this material, see the patent document WO 99/43870. Further, said base body 3 has a three-dimensionally formed emission surface 3′. In the embodiment shown in FIG. 1 this three-dimensionally formed surface 3′ has an essentially square-wave formed cross section, for example as shown in FIG. 2a, but the field emission cathode 1 may have other cross sections, as shown in FIG. 2b and 2c. The forming of the surface structure may be made by cutting or by other per se known methods, and this will not be described here.

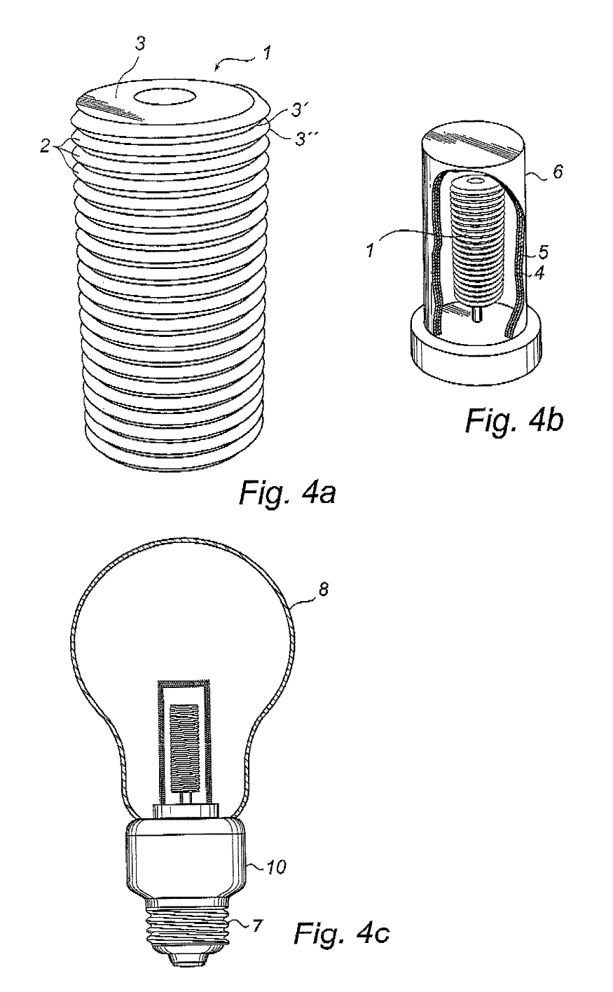

One example of a cathode is shown in FIG. 4a-4c. FIG. 4a shows the cathode base body 3, essentially formed as a cylinder On the cylinder surface 3′ of said body an essentially helical protrusion is formed, resulting in protruding emission surfaces 3′. The emission surfaces essentially have the appearance of the corresponding emission surfaces of FIG. 1, being covered with a nanostructured material. Said nanostructured material has a random structure. Thus, the base body 3 may be said to have a large and a small-scale structure. The large scale structure is constituted by said forming of the emission surface and the protruding emission surfaces 3″, and is preferably periodical and the small scale structure is constituted by said random pore structure of the base body material, and is non-periodical. The open cell structure of the base body material is highly advantageous compared with more homogeneous materials in that it for the same applied voltage produces a higher field emission density over the structure.

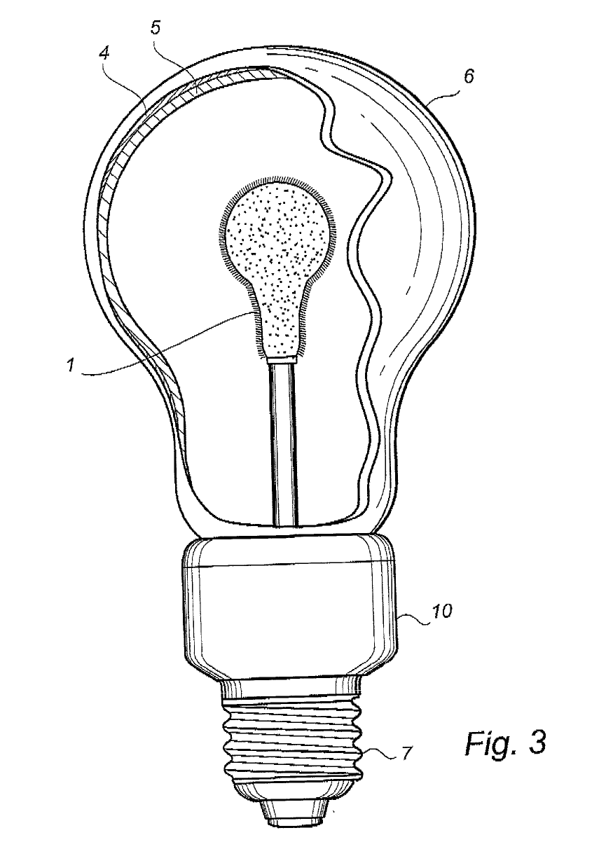

Consequently, due to the three-dimensional surface structure, there are areas of the emission surface being positioned closer to a presumptive anode, than other areas of the emission surface 3′. These protrusions 3″will, due to a shorter distance to a presumptive anode, define the emission areas of the emission surface 3′ due to the fact that field emission is distance dependent, and the areas of emission may therefore be controlled. As seen in FIG. 4b, as well as in FIG. 3, the distance between the emission surfaces 3″ and an anode 5 is essentially constant, providing an even field emission from the cathode to the anode, since field emission is distance dependent.

The embodiment as shown in FIG. 4b is a so-called diode mode cathode. It is also possible to include a grid or the like (not shown) between the cathode 1 and the anode 5 in order to control the emission flow. This kind of cathode is referred to as a triode mode cathode.

As best seen in FIG. 1, the emission surface 3′ of the base body 3 is, at least partly, covered with a nano-structured material 2. In the embodiment shown in FIG. 1 only the protrusions 3′ of the three-dimensional surface 3′ are covered with the nano-structured material 2, since these, due to the facts stated above, are the only areas from which emission is likely to occur. However, due to manufacturing techniques it is often simpler and less expensive to cover the entire emissive surface 3′ with the nano-structured material 2. This nano-structured material 2 may be accomplished either by treating the material of the base body 3 in order to create nano-structures on its surface or by applying a separate layer of carbon nanotubes (CNT) on the emission surface 3′ of the base body 3 on per se known manners. Said nanotubes may be single wall nanotubes (SW/CNT), Multi wall nanotubes (MW/CNT) or multi wall open nanotubes (MWO/CNT), each with previously known features and advantages. In any case, said nano structures 2 constitute emission points and their emissive ends are treated and trained in order to stabilize the emission current during emission. This training may be done in various ways, for example as in the applicant's previous patent application PCT/SE00/01226, and this will not be further described here.

In FIG. 3 a light source with the appearance of a regular light bulb is shown. The light source comprises a bulb 6 constituting an evacuated chamber, said bulb 6 being attached to a regular size socket 7. Between the socket 7 and the bulb 6, a casing 10 is arranged, in which electronic circuits needed to operate the lamp is positioned, The inside of the bulb 6 is at least partly coated with two overlapping layers, a first layer 5 by a conductive material constituting an anode and a second layer 4 by a fluorescent material. A field emission cathode 1 of the above-described type is incorporated in the bulb, and the cathode surface has essentially the same shape as the inner surface of said bulb 6. The anode 5 as well as the cathode 1 is electrically connected with respective terminals of the socket 7 for enabling application of an electric field over the cathode 1 and anode 5. The above-described configuration may be referred to as a diode mode. Further, the above described light source may be equipped with an electrically connected grid or modulator (not shown) arranged between the cathode 1 and the anode 5 in order to further control the streams of electrons from the cathode I to the anode 5. This case is referred to as triode mode.

When putting a voltage over the cathode 1 and the anode 5, electrons will emanate from the nanotube layer 2 of the cathode 1 and move towards the anode 5. When the electrons hit the fluorescent layer 4, light will emit through the anode 2 and the bulb 6 resulting in illumination of the surrounding area.

An alternative embodiment of the invention is shown in FIG. 4a-4c. Here the light source comprises an evacuated chamber 6, said chamber 6 being attached to a regular size socket 7. The inside of the chamber 6 is at least partly coated with two overlapping layers, a first layer 5 by a conductive material constituting an anode and a second layer 4 by a fluorescent material. A cylindrical field emission cathode 1 of the above-described type is incorporated in the chamber 6. The anode 5 as well as the cathode 2 is electrically connected with respective terminals on the socket 7. Further, an electrically connected modulator (not shown) may be arranged between the cathode 1 and the anode 5. Moreover, this construction includes a cover/diffusor 8, with the appearance of a regular light bulb. This construction has a great advantage in that the inner evacuated chamber 6 may be made as a small standard component and may later be equipped with covers of different shapes and colors, creating different spreading of the light as well as different color temperatures. The diffusor may be manufactured from various glass and plastic materials.

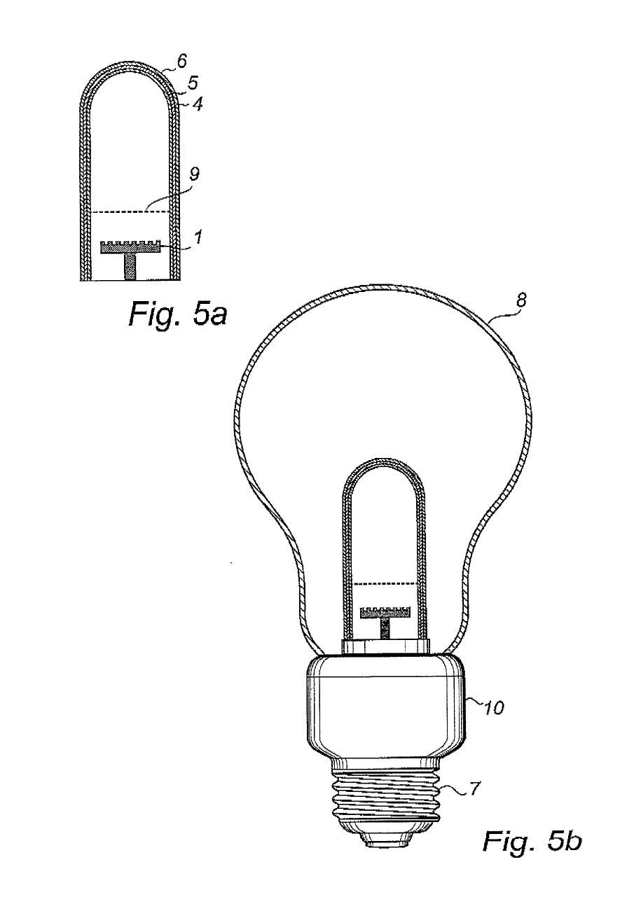

Yet another embodiment of the invention is shown in FIG. 5a-5b. This embodiment differs from the embodiment shown in FIG. 4a-4c only in the configuration of the evacuated chamber 6. A field emission cathode 1 of the type shown in FIG. 1 is incorporated in the chamber 6. The anode 5 as well as the cathode 2 is electrically connected with respective terminals on the socket 7. Further, an electrically connected modulator 9 is arranged between the cathode 1 and the anode 5. Moreover, this construction also includes a cover/diffusor 8, with the appearance of a regular light bulb.

As mentioned above, a cathode construction according to this invention is highly suitable for mass production. This is for example due to simple shaping of the base body and the nano-structured material. This shaping, as for example described in WO 99/43870, may be done by laser cutting. Laser cutting of for example Reticulated Vitreous Carbon™ result in a shorter training period (also called aging periods) for the cathode before a stabilization of the emission current is achieved. This is due to the fact that laser cutting introduce fewer contaminants to the emission surface than for example manual cutting, and consequently a clean surface, adapted for use in vacuum, is produced on the cathode, without the need of gassing or the like. Consequently, the training and the cutting may be done in one step, resulting in easy manufacture. However, a presently preferred method of producing the above described field emission cathode is described in the PCT patent application with application number PCT/SE00/01226.

Many different embodiments apart from the ones being described above can be made within the scope of this invention. For example, the above-described cathode may have other shapes and cross sections than those described above. The cathode may for example be planar. Further, the appearance of the light source may be varied in order to create lamps for different purposes. Moreover, the base body shown is essentially plane and provided with a layer of nanotubes on one side. It is however possible to create a cylindrical base body with circumferencially arranged nanotubes. Other possible shapes of the base body are for example spheres or cubes.

The light source may or may not be equipped with a screw base or the like, in order to fit different standards, and further, drive electronics for the light source may be integrated with the socket.

Further, in the above described embodiments, the second layer 4 by a fluorescent material is arranged on the inner surface of the bulb/evacuated chamber 6 and the first layer 5 by a conductive material constituting an anode is arranged upon said second layer 4, as best seen in FIG. 3. However, in accordance with prior art, the position of these layers may be interchanged.

Although the above cathode is referred to as a cathode used in a light source, it is also possible to construct for example cathode-ray tubes using the above-described cathode.

Finally it shall be understood that even if the materials of the cathode described above are very suitable for this field emission application, there are other materials, such as other vitreous carbon materials, that may be used for said cathode.

1. A field emission cathode (1) for a light source, said cathode (1) comprising at least one base body (3) having an emission surface (3′) characterized in that said base body (3) is formed by a structured, oriented material, and said emission surface (3′) is at least partly covered by a field emitting nano-structured material (2).

2. A field emission cathode according to claim 1, wherein said emission surface (3′) of said base body (3) is formed as to constitute a three dimensional surface structure, including several protruding areas (3″), at least said protruding areas (3″) being covered by nano-structured material (2).

3. A field emission cathode according to claim 2, wherein said protruding areas (3′) are arranged to form an essentially periodical surface structure.

4. A field emission cathode according to claim 3, wherein said periodical surface structure has an essentially square-wave cross section.

5. A field emission cathode according to claim 3, wherein said periodical surface structure has an essentially sinusoidal cross section.

6. A field emission cathode according to claim 3, wherein said periodical surface structure has an essentially saw-tooth shaped cross section.

7. A field emission cathode according to any one the claims 1-6, wherein said structured, oriented material is constituted by a porous carbon material such as a porous carbon foam material, e.g. Reticulated Vitreous Carbon™.

8. A field emission cathode according to any one of the claims 1-6, wherein said structured, oriented material is constituted by a semiconductor material.

9. A field emission cathode according to anyone of the claims 1-8, wherein said carbon nano structured material (2) is constituted by a layer of carbon nanotubes arranged on said base body (3).

10. A field emission cathode according to anyone of the claims 1-9, wherein said emission surface (3′) is entirely covered by a field emitting carbon nano structured material (2).

11. A light source, comprising an anode (5), a cathode (1) and an evacuated container (6) enclosing said anode (5) and said cathode (1), wherein said container (6) have at least one inner wall being provided with a luminescent layer (4) as well as a conductive layer forming said anode (5), characterized in that said cathode (1) is a field emission cathode as defined in any of claims 1-8.

12. A light source in accordance with claim 11, wherein said evacuated container (6) is arranged to form the outer boundaries of the light source.

13. A light source in accordance with claim 11, wherein said evacuated container (6) is essentially enclosed in a cover (8) being arranged to form the outer boundaries of the light source.
